(19) United States
(12) Patent Application Publication
(10) Pub. No.: US 2015/0371204 A1
(43) Pub. Date: Dec. 24, 2015

(54) RIDESHARING SYSTEM AND METHOD

(71) Applicant: Dabble Apps, LLC, Indian Harbour Beach, FL (US)

(72) Inventors: Daniel Balda, Indian Harbour Beach, FL (US); Sean Marcus, Rockledge, FL (US)

(73) Assignee: Dabble Apps, LLC, Indian Harbour Beach, FL (US)

(21) Appl. No.: 14/747,688

(22) Filed: Jun. 23, 2015

Related U.S. Application Data
(60) Provisional application No. 62/015,880, filed on Jun. 23, 2014.

(51) Int. Cl. G06Q 20/14; G06Q 50/00; G06Q 10/02; G06Q 30/02; G01S 19/14; G07B 15/00

(52) U.S. Cl. CPC G06Q 20/145; G01S 19/14; G07B 15/00; G06Q 10/02; G06Q 30/0282; G06Q 50/01

(57) ABSTRACT

A method of organizing and confirming aircraft transportation for a user may comprise the steps of transmitting flight information for display on a user device, receiving location information indicating a location of the user from a GPS device comprised by the user device, determining a location verification defined as whether the location of the user indicated by the location information is within a range of a location associated with the flight information, and billing the user for transportation on the flight associated with the flight information responsive to the location verification.

### RELATED APPLICATIONS

This application is related to and claims benefit under 35 U.S.C. §119(e) of U.S. Provisional Patent Application Ser. No. 62/015,880 titled Ridesharing System and Method filed Jun. 23, 2014 (Attorney Docket No. 752.00001), the content of which is incorporated by reference herein in its entirety, except to the extent disclosure therein is inconsistent with disclosure herein.

### FIELD OF THE INVENTION

The present invention generally relates to ridesharing services and systems used to implement ridesharing. In particular, the present invention relates to a method and system for coordinating, and verifying ridesharing in airplanes and other similar modes of aeronautical transportation.

### BACKGROUND OF THE INVENTION

Travelers are increasingly seeking methods to tailor various forms of travel to their particular needs, while at the same time attempting to save money. As a result, carpooling, applications to call a driver or taxi, and even online hitch hiking have emerged. Demand for similar services in the high-end transportion, including private air transportation, has similarly increased. Previous solutions have typically required large up-front payments and subscription services, reducing the flexibility of such access to transportation. Accordingly, there is a need in the art for a similar method of tailoring air transportation to particular needs, in addition to the increased flexibility in travel such systems provide.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Air-travel, however, is still a relatively costly endeavor, particularly the chartering of, or sharing the costs of travel in, private planes. There is not currently a system in place to guard against fraud or claims that a service was not delivered when using apps, or other similar services, to share the cost of a flight while providing a simple billing process.

An exemplary aspect of the invention includes a system to coordinate among the passengers to arrange a flight, check whether all passengers are present at departure, and check whether all passengers arrive at a particular destination. The system can also provide automatic payment when the destination is reached (or once the user departs from the departure location), and the ability to rate their fellow air passengers and other aspects of the flight. In particular the system allows passengers, pilots, etc. to rate the other passengers, the pilot, the plane, and other flight related items to allow users to make informed decisions on whom to travel with.

In an exemplary embodiment, a user can download an app or program onto their digital device, such as a phone or tablet, which serves as the interface of the ride sharing system. This downloaded program also can serve as a geo-locator by using the digital device, such as a phone with GPS or antenna positioning capability, to determine the user's location. The system can evaluate the user's location relative to the distance from the departure and arrival location to determine arrival or departure, or can use a geo-fence concept to determine arrival and departure once the user arrives at or leaves a predefined area.

An embodiment of the application can allow the user to enter a desired destination and search for available flights or combinations of flights, or the user can view which flights are available by departure point, arrival point, or time. Due to the location feature, the application can also automatically display flights leaving from locations close to the user.

The system can be configured to provide for automatic payment based on a predetermined event. For example, payment can be automatically made when the trip is completed. Other triggers for payment are also possible, such as upon the arrival of the person at a destination, the departure from a destination, when the final destination is reached, or upon reserving a place on a flight.

The automatic billing options, when combined with the ability to sense the location of the passenger/customer, can be leveraged to remove the need for tickets when ride sharing. The inventive method can advantageously remove the need for tickets in traditional commercial airline travel.

A method aspect of the present invention is directed to organizing and confirming aircraft transportation for a user. The method may comprise the steps of transmitting flight information for display on a user device, receiving location information indicating a location of the user from a GPS device comprised by the user device, determining a location verification defined as whether the location of the user indicated by the location information is within a range of a location associated with the flight information, and billing the user for transportation on the flight associated with the flight information responsive to the location verification.

In some embodiments, the step of determining the location verification may comprise determining if the location information indicates a location within a range associated with at least one of an origination location and a destination location associated with the flight information. Furthermore, the step of determining the location verification may comprise determining if the location information indicates a location within a pre-defined geofence associated with an origination location associated with the flight information. The step of determining the location verification may comprise determining if the location information indicates a location within a pre-defined geofence associated with a destination location associated with the flight information.

The step of receiving location information indicating a location of the user may comprise receiving location information indicating a first location of the user at a first time and receiving location information indicating a second location of the user at a second time. Furthermore, the step of determining the location verification may comprise determining a first location verification defined as whether the first location is within a range of an origination location associated with the flight information at the first time, and determining a second location verification defined as whether the second location is within a range of a destination location associated with the flight information at the second time. Additionally, the step of determining if the first location is within a range of the origination location associated with the flight information may comprise determining if the first location is within a pre-defined geofence associated with the origination location which, in turn, may be associated with the flight information. Also, the step of determining if the second location is within a range of the destination location associated with the flight information may comprise determining if the second location is within a pre-defined geofence associated with the destination location which, in turn, may also be associated with the flight information.

Additionally, the step of billing the user for transportation on the flight associated with the flight information responsive to the location verification may comprise billing the user for transportation on the flight associated with the flight information responsive to the first location verification indicating the user was within the range of the origination location at the first time and the second location verification indicating the user was within the range of the destination location at the second time.

In some embodiments, the method may further comprise the steps of transmitting flight information related to a plurality of flights for display on the user device and receiving reservation information regarding at least one of the plurality of flights from the user device.

The method may further comprise the step of receiving verification of the presence of the user on an aircraft associated with the flight information. Furthermore, the step of receiving verification of the presence of the user on the aircraft associated with the flight information may comprise receiving confirmation of the presence of the user from a flight crew device associated with a member of a flight crew. Additionally, the step of receiving confirmation of the presence of the user from a flight crew device may comprise receiving at least one of a registration or booking code, name identification confirmation, picture identification confirmation, and confirmation of establishing a link with the user device from the flight crew device.

The method may still further comprise the steps of receiving a user rating from the user device comprising a rating for at least one of the flight, a flight crew member, the aircraft, or another passenger associated with the flight and storing the user rating in a user rating database. The user rating database may comprise a plurality of user ratings, and the method may further comprise the steps of accessing a user rating associated with the user, determining one or more preferences responsive to the user rating associated with the user, and transmitting flight information to the user responsive to each of the preferences and the location of the user.

The method may also comprise the step of receiving interest information associated with a social media site associated with the user from the user device. The method may further comprise the step of providing on the aircraft at least one of reading material, audio playback, and food and/or drink responsive to the interest information. Additionally, the method may comprise the step of transmitting flight information to the user device responsive to the interest information.

The step of billing the user for transportation on the flight associated with the flight information may be performed responsive to the location indicated by the location information being at least one of a location within a range of an origination location associated with the flight information, within a range of a destination location associated with the flight information, within a pre-defined geofence associated with an origination location associated with the flight information, and within a pre-defined geofence associated with a destination location associated with the flight information.

### BRIEF DESCRIPTION OF THE DRAWINGS

FIG. 1 is a flow chart that illustrates an exemplary method of performing ride sharing according to the present invention.

FIG. 2 is a flow chart that illustrates another exemplary method of performing ride sharing according to the present invention.

FIG. 3 illustrates an exemplary system for ride sharing.

FIG. 4 illustrates an exemplary computer system.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

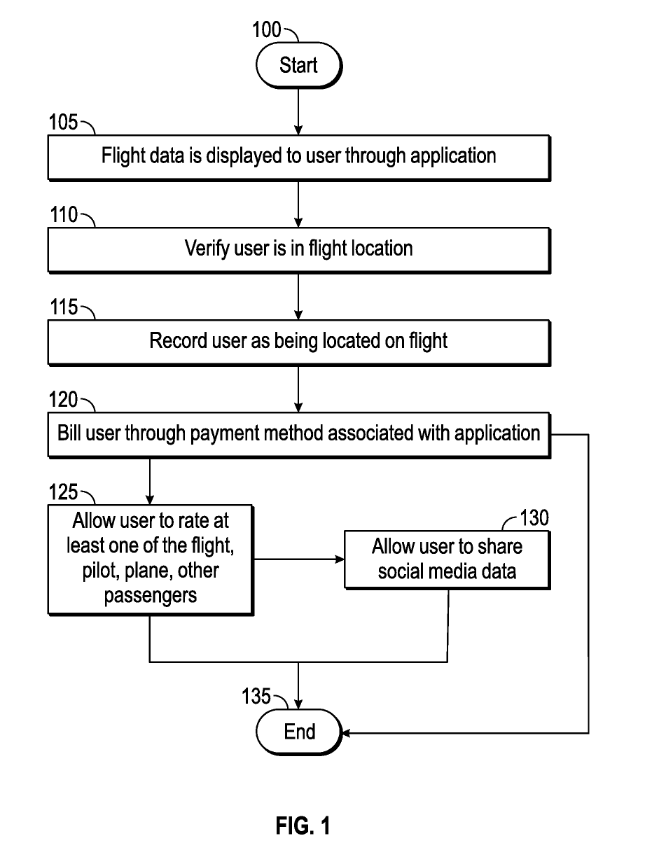

Referring now to FIGS. 1-4, there are shown exemplary embodiments of the method and system according to the present invention.

An exemplary aspect of the invention applies to a system and application for performing ridesharing of flights. In particular, an exemplary embodiment of the invention includes an application on a user's mobile device to coordinate the sharing of flights. Data may be transmitted to and from the application on the user's mobile device in order to facilitate the organization of aircraft transportation.

In an exemplary embodiment, the user travels on a flight and their location at a point in time related to the flight is tracked or recorded through the application. The location of the user may be provided by any type of geo-locating feature of the user's mobile device, such as a GPS device comprised by the user device. The location of the user, as verified through the mobile device with the application, triggers an automatic billing for the user's flight and related services. Furthermore, the location information of the user may be transmitted to and received by a remote computer, such as a server, associated with the application.

As an example, a method aspect of the present invention is illustrated in the flowchart of FIG. 1. From the start (Block 100) flight data may be transmitted to and displayed to a user through the application loaded on the user's mobile device at Block 105. More particularly, when registered users, which are present on a flight (at arrival, departure, or while in flight), or when a condition occurs, each person's information, which can include a picture, may be displayed through the application. Those skilled in the art will appreciate, however, that other identifying information may be provided on the application. As an alternative, if the user's identity or privacy is a concern, the application may simply indicate that the user/passenger is present based on the location of their mobile device, such location being transmitted in the form of location information.

At Block 110, an application user, such as a pilot, can verify through the application that everyone is present by referring to each person's information. For instance, the pilot can ask for a registration or booking code from the passenger to ensure it matches the information displayed on the pilot's application. The pilot's application may be fun on a flight crew device. It is contemplated and included within the scope of the invention that any other member of the flight crew, including flight attendant, co-pilot, and the like, may similarly perform verification of the presence of a passenger/user. The flight crew device may be associated with one or more members of the flight crew and/or associated with the flight associated with the flight information. The pilot/user could match the passenger/user to the name listed on the pilot's application program (e.g., perhaps check identification document if required). Further, the pilot/user could compare a picture provided through the application with that of the passenger/user. Alternatively, the mobile device of the pilot/user could automatically link wirelessly with the mobile device of the passenger/user to verify passenger. Those skilled in the art will appreciate that the identity and verification of users on the flight can be achieved in any other number of ways as well, which is intended to be included in the scope of the present invention.

At Block 115, the location of each user may be verified as being within a range of the flight origination location, in flight, and/or the flight destination location and saved. Additionally the user's location can be detected through the application so as to geo-fence the locations of the users at that point in time. Thus, all of the passengers using the application can be recorded as being within a certain area at a particular time. For instance, the application can update the system's database with the user's location. If the user is located at a plane or other set area (e.g., airport), then the system will save the user's location and will note that the user may be on a flight at that location. When the flight arrives at its destination, the location of the user is again compared with that of the plane, destination airport, etc. If the user is located near the plane or destination airport it is determined that the user was on the flight and a fee that may be associated with the flight can be automatically charged to payment information associated with the user that is stored in a database associated with the application.

The timing and method of recording the user's location is not particularly limited. In exemplary embodiments, the user's location can be verified when the flight is in the origination location, such as on the plane or at the departing airport, at a point on the flight, and at the destination location of the flight. More specifically, a first location verification may be determined, wherein whether the user is within a range of the origination location associated with the flight information at a first point in time is determined. Additionally, a second location verification may be determined, wherein whether the user is within a range of the detination location associated with the flight information at a second point of time is determined. The first point in time may be associated with at least one of a boarding, taxying, and take-off time of the flight associated with the flight information, and the second point in time may be associated with at least one of a landing, taxying, and de-planing time of the flight associated with the flight information. The system can use any one, or a combination of, these location verifications to determine that the user was present on the flight.

The triggering event for determining a user's location is not particularly limited. For instance, the application may detect the user's location periodically and send this information to a database. The database can also store information related to the location of the plane, other users who might be on the same flight, or the location of the pilot of the flight. Thus, the system can determine when the user is within a vicinity of the pilot, plane or other passengers on the flight to determine a start point for the user.

Determining the location of the user of the application at the start point is generally triggered after a user makes a reservation using the application. In other words, the user may reserve a flight using the application. After the user has reserved the flight using the application, the user may have the option to be charged a fee for the flight upon making the reservation. Alternatively, the user may be presented with the option to be charged automatically upon completion of the flight. If the user so chooses to be charged automatically upon completion of the flight, then at the time when the flight is to depart, the application may determine the location of the user that has reserved the flight, or may otherwise verify that the user is on the flight at the starting location, as described above.

In addition, the application may record the user's location upon an input from the user or automatically from another prompting source. For instance, an action of the user can cause the application to indicate they are at the flight location. This could be done from the application screen by interacting through a graphic user interface (GUI) or other input medium. This could also be done through connecting to a pilot's (or other user's) device, a plane's wireless network, etc., which may also be running the application. An additional option, is that once the user signs up for a particular flight, once that flight time is within a certain time range (e.g., an hour or a day before the planned departure time), the application may automatically start recording the user's location.

In another example, the user's application may be prompted by another user, such as a pilot, to record the user's/passenger's location. This may be done by an active input on the part of another user or system, or may be done automatically when the mobile device application determines other user's are within a certain range (e.g., through a Wi-Fi or other wireless detection, a tracking database in the system, etc.).

For instance, when the pilot (or other personnel related with the aircraft) is loading passengers or preparing for departure, while the flight is in transit, or at arrival to the destination, the pilot (or other user) can request the system to record the location of each user to verify they are on the flight.

In some embodiments, the application may periodically check the user's location and may only record (whether stored locally or at a remote database) the user's location when they are within a certain area. The areas can act as a “geo-fence” are not particularly limited. For instance, a geo-fence can be a fixed location such as an airport, a city, or region. In addition, a geo-fence can be a potentially dynamic location, such as a plane (or a certain distance to a plane), a proximity with other user's or a pilot, etc.

In addition, the user can be recorded as being on the plane without the use of their mobile device. For instance, the pilot may simply enter into his application that the user is/was on board. For a more verifiable method, the pilot may take a picture of the user or may enter in a code provided by the user. The code can be generated by the application or may be the user's own created “secret code”. This or other methods of verification of location may be done as an alternate method or may be done if one or more user's mobile devices are not available (e.g., turned the user's phone is turned off).

An exemplary embodiment may use this information, combined with location information related to the user, to determine if the user has taken a particular flight. This can be based on a flight the user had registered to take, or can even dynamically track which flights the user takes without pre-registration. Therefore, in some embodiments, the user may simply get on a flight and the application will take care of tracking and billing without the need for reservations or tickets. At Block 120, the user may then be billed based on account settings associated with the application (e.g., a credit card associated with the account, online payment service, user account, etc.).

The method of payment associated with the user is not particularly limited. In some embodiments, the user will setup a credit card, bank account, online payment service, or account balance with a company associated with the system.

For instance, when the user sets up the application it is linked to the user's account. The user can setup the account to have one or more default payment methods based on particular conditions.

Also, for example, for fees of a certain amount the cost may be deducted from the user's credit with the company. For different amounts, the payment could be charged to the user's credit card or withdrawn from a bank account. Alternatively, all charges can be set to a certain payment method.

As another alternative, the user may set the payment type when the user registers for the flight. In this instance, the method of payment may be set beforehand for the specific flight, or portion of the flight, and can then be automatically charged when the proper conditions occur.

In addition, the user can set the application so that, prior to billing, the user is given the opportunity to the change billing method. This may be in the form of a notification and then a set amount of time to change billing options prior to the automatic billing occurring.

At Block 125, the users can then rate aspects of the flight.

The aspects of the flight the user can rate are not particularly limited and can include the plane, the other passengers (collectively or individually), the pilot, the stewardess, the airport, etc., or any combination thereof. The user may be prompted at the end of the flight, after they have been charged, a set time period after the flight, etc.

The user's ratings and preferences may be stored locally by the application or remotely via the system. More specifically, the user's ratings and preferences may be stored in a user rating database. This can allow the system to automatically try to pair users with their preferred passengers, pilot, plane, etc. by accessing a user rating associated with the user. Similarly, the system can try to make sure the user is not paired with passengers, planes, etc. which were given a poor rating by the user. The system can also use the user's likes and dislikes to determine preferences, and send their preferences to the flight crew beforehand (e.g., the user's preferred drink, music, etc.). As such, flight information transmitted to the user's device may be responsive to the user's preferences.

Thus, the application can automatically try to match the user with flights that will match their preferences (e.g., plane, pilot, passengers, etc.). At Block 130, the users can share social media data with each other.

In some embodiments, the user can be given an option to send or request another passenger's social media contact information. Thus, two passengers can link to one another through their preferred social media sites. In addition, the system may include its own social media which the passengers may join and share information with.

It is also possible to have the system gather data from the user's social media sites. For instance, the application may gather information on the user's favorite music artist, drink, etc. and then send this information to the flight. Thus, when the user arrives he his music will already be playing and the crew can ensure his drink of choice is available. The application may also track activities on a user's social media site. For example, if it appears that a user is interested in exercise activities, the application may make note of the user's interests to ensure that certain accommodations can be provided to the user. More particularly, and with respect to the above example, for a user that may be interested in exercise activities, it may be preferable to include reading materials related to exercise activities to be available on the plane. Further, it may be determined that some users prefer certain types of drinks. In such a case, it may be preferably to ensure that the user's favorite drink is carried aboard the plane.

Through interacting with the user's social media site, the system can send the user possible flights if it is detected the user is planning a trip, has a favorite place, somewhere they want to travel to, etc. The social media aspect can also be used for combinations of users. For example, if some of the users are planning a trip to the same location (and perhaps rate each other highly), this may be detected from social media posts. In this case, the application could see if there is a flight to share which would accommodate the users and then send the users the proposed flight information.

In addition, the rating system could be handled through a social media site. For example, the company associated with providing the application or flight may have a presence on the social media sight. The method is ended at Block 135.

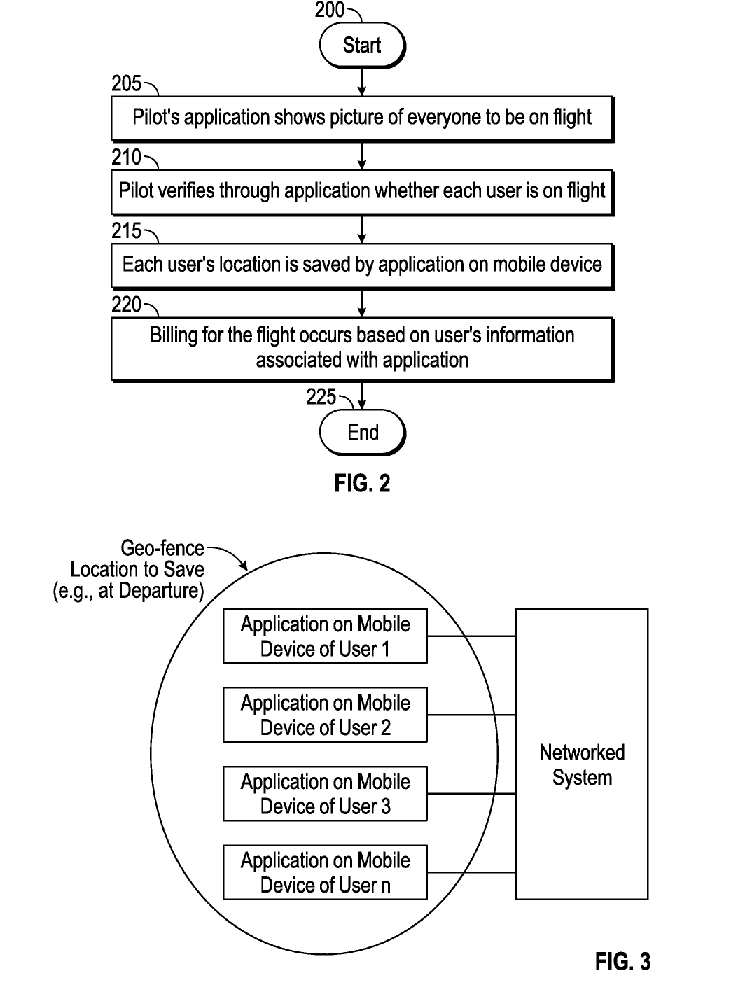

FIG. 2 illustrates an example of an embodiment of the system. Starting with Block 200, the pilot's application may show a picture of everyone on the plane at Block 205. The pilot can then click on everyone (or select each user) that is registered on the plane to indicate the person is present at Block 210. At this point, each user's mobile device may be geo-fenced in the new location, including the pilot's mobile device at Block 215. Billing can occur at this point or some point thereafter (e.g., at departure, once the departure site has been left, while in transit, at destination, etc.) at Block 220. The method ends at Block 225. This system can reduce or eliminate the opportunity for fraud, as each person registered for a flight will be checked and the mobile device location will confirm that they were on the flight.

The passengers and pilot can also, if desired, rate other people on the flight, the flight accommodations, and other information related with the flight. The application can also allow the passengers/pilot, etc. to share social media information and links to a social media site.

An exemplary, non-limiting, use of the application will now be described. In this example, the user may search the application for flights leaving from a certain location/region and arriving at a certain destination. The application may then display which flights, or combinations of flights are available to the user. The user may then register to share a flight with three other people. The user arrives at the flight and the pilot (for example) receives a picture of each passenger on the computer application. The pilot then checks off each user who is on the flight and the pilot and four passengers are “geo-fenced” through their phones at the current location. Once the user arrives at the destination, the user's phone (or other device that may be connected to the internet and that may allow for the application to run), through the application, registers the user's location as being at the destination. The user is then automatically billed (e.g., for his share of the flight).

The above system can protect against claims that the user was not present as the user's location is verified at the departure and arrival points. In addition, the user was registered as present by a third party (in this case the pilot).

In another exemplary embodiment, the user may check which flights are available on his/her application. Optionally, the user may register for one of the flights to share. Once the user arrives at the departure location, his/her location may be saved by the application. When the user arrives at the flight destination, the application records his/her location and automatically pays for the flight.

While the above embodiments describe specific examples for the purpose of illustration, the system can be altered to suit the needs of the business. The time of billing, time and method of location detection, and manner of looking up or registering for flights can be varied by one of ordinary skill in the art given the needs of the particular method of travel (e.g., charter vs. private plane).

For instance, the automatic billing can occur at the time of registration, time or location of departure, time or location of arrival, etc. The automatic billing can also occur after each flight of a multiple flight trip or can occur once the final destination is reached. Verification that the user is on the flight can be based on the location of the mobile device, the location of the mobile device in relationship to the other passenger's/pilot's mobile device, by a user checking that the other user's picture/information matches who is there, by direct mobile device to mobile device communication, etc.

As illustrated in FIG. 3, an embodiment of the system can be formed of one or more networked systems and the user's mobile device having the application (program) loaded thereon. The amount of processing which occurs at the mobile device level (e.g., filtering flight information, calculating rate, etc.) can be set based on the device or by general rules and is not particularly limited.

While exemplary embodiments have been described in relation to flight sharing, the invention is not particularly limited to air travel. In addition to applying to air transportation, exemplary embodiments of the invention may include any mode of transportation such as car pools, boating/ships, busses, etc. For example, in the case of boating vacations, the present invention may advantageously be used with respect to yacht sharing. In such an embodiment, the system according to the present invention may detect when a user is within a particular vicinity of a yacht, and may also detect when the user is located at various ports. Accordingly, charges can be made depending on which ports the user is detected at.

Indeed, exemplary embodiments of the invention may used for shipping cargo, or any endeavor where an item is in transit. For instance, a wireless device or radio frequency identification chip can be attached to the cargo to verify location. Alternatively, any of the other discussed methods of location verification, or variations thereof, can be used such as verifying data presented on an interface with the item being shipped, etc. Similarly, any of the discussed billing systems, or variations thereof, may be used.

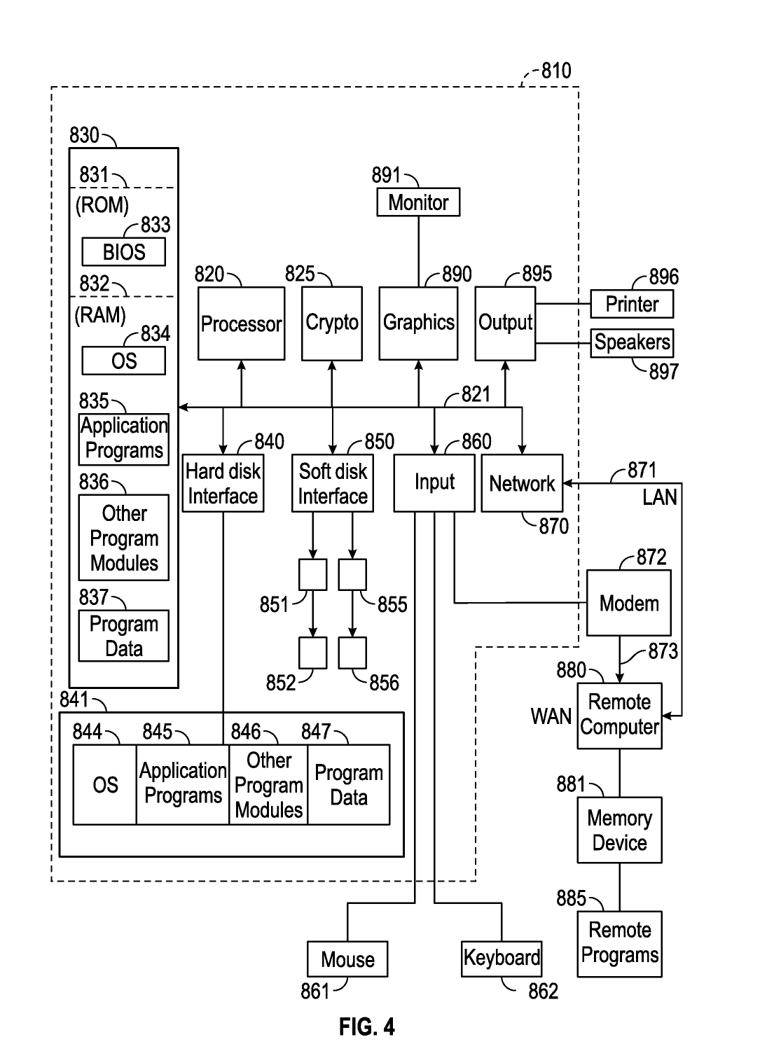

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 4 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 4 illustrates an operating system (OS) 834, application programs 835, other program modules 836, and program data 837.

The computer 810 may also include other removable/non-removable, volatile/nonvolatile computer storage media. By way of example only, FIG. 4 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 4, provide storage of computer readable instructions, data structures, program modules and other data for the computer 810. In FIG. 4, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 4. The logical connections depicted in FIG. 4 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 4 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of organizing and confirming aircraft transportation for a user comprising the steps of:
transmitting flight information for display on a user device;
receiving location information indicating a location of the user from a GPS device comprised by the user device;
determining a location verification defined as whether the location of the user indicated by the location information is within a range of a location associated with the flight information; and
billing the user for transportation on the flight associated with the flight information responsive to the location verification.

2. The method according to claim 1 wherein the step of determining the location verification comprises determining if the location information indicates a location within a range associated with at least one of an origination location and a destination location associated with the flight information.

3. The method according to claim 1 wherein the step of determining the location verification comprises determining if the location information indicates a location within a pre-defined geofence associated with an origination location associated with the flight information.

4. The method according to claim 1 wherein the step of determining the location verification comprises determining if the location information indicates a location within a pre-defined geofence associated with a destination location associated with the flight information.

5. The method according to claim 1 wherein the step of receiving location information indicating a location of the user comprises:
receiving location information indicating a first location of the user at a first time; and
receiving location information indicating a second location of the user at a second time.

6. The method according to claim 5 wherein the step of determining the location verification comprises:
determining a first location verification defined as whether the first location is within a range of an origination location associated with the flight information at the first time; and
determining a second location verification defined as whether the second location is within a range of a destination location associated with the flight information at the second time.

7. The method according to claim 6 wherein the step of determining if the first location is within a range of the origination location associated with the flight information comprises determining if the first location is within a pre-defined geofence associated with the origination location associated with the flight information.

8. The method according to claim 6 wherein the step of determining if the second location is within a range of the destination location associated with the flight information comprises determining if the second location is within a pre-defined geofence associated with the destination location associated with the flight information.

9. The method according to claim 6 wherein the step of billing the user for transportation on the flight associated with the flight information responsive to the location verification comprises billing the user for transportation on the flight associated with the flight information responsive to the first location verification indicating the user was within the range of the origination location at the first time and the second location verification indicating the user was within the range of the destination location at the second time.

10. The method according to claim 1 further comprising the steps of:
transmitting flight information related to a plurality of flights for display on the user device; and
receiving reservation information regarding at least one of the plurality of flights from the user device.

11. The method according to claim 1 further comprising the step of receiving verification of the presence of the user on an aircraft associated with the flight information.

12. The method according to claim 11 wherein the step of receiving verification of the presence of the user on the aircraft associated with the flight information comprises receiving confirmation of the presence of the user from a flight crew device associated with a member of a flight crew associated with the flight information.

13. The method according to claim 12 wherein the step of receiving confirmation of the presence of the user from a flight crew device comprises receiving at least one of a registration or booking code, name identification confirmation, picture identification confirmation, and confirmation of establishing a link with the user device from the flight crew device.

14. The method according to claim 1 further comprising the steps of:
receiving a user rating from the user device comprising a rating for at least one of the flight, a flight crew member, the aircraft, or another passenger associated with the flight; and
storing the user rating in a user rating database.

15. The method according to claim 14 wherein the user rating database comprises a plurality of user ratings; and wherein the method further comprises the steps of:
accessing a user rating associated with the user;
determining one or more preferences responsive to the user rating associated with the user; and
transmitting flight information to the user responsive to each of the preferences and the location of the user.

16. The method according to claim 1 further comprising the step of receiving interest information associated with a social media site associated with the user from the user device.

17. The method according to claim 16 further comprising the step of providing on the aircraft at least one of reading material, audio playback, and food and/or drink responsive to the interest information.

18. The method according to claim 16 further comprising the step of transmitting flight information to the user device responsive to the interest information.

19. The method according to claim 1 wherein the step of billing the user for transportation on the flight associated with the flight information is performed responsive to the location indicated by the location information being at least one of a location within a range of an origination location associated with the flight information, within a range of a destination location associated with the flight information, within a pre-defined geofence associated with an origination location associated with the flight information, and within a pre-defined geofence associated with a destination location associated with the flight information.

20. A method of organizing and confirming aircraft transportation for a user comprising the steps of:
transmitting flight information for display on a user device;
receiving confirmation of the presence of the user on an aircraft associated with the flight information from a flight crew device;
receiving location information indicating a first location of the user from a GPS device comprised by the user device at a first time;
determining a first location verification defined as whether the first location is within a range of an origination location associated with the flight information at the first time;
receiving location information indicating a second location of the user from the GPS device comprised by the user device at a second time;
determining a second location verification defined as whether the second location is within a range of a destination location associated with the flight information at the second time; and
billing the user for transportation on the flight associated with the flight information responsive to the first location verification indicating the user was within the range of the origination location at the first time and the second location verification indicating the user was within the range of the destination location at the second time.

21. A method of organizing and confirming aircraft transportation for a user comprising the steps of:
accessing a user rating associated with the user from a user rating database;
determining one or more preferences responsive to the user rating associated with the user; and
transmitting flight information for display on a user device responsive to each of the preferences and the location of the user;
receiving interest information associated with a social media site associated with the user from the user device;
providing on the aircraft at least one of reading material, audio playback, and food and/or drink responsive to the interest information;
receiving confirmation of the presence of the user on an aircraft associated with the flight information from a device associated with a member of the flight crew associated with the flight information;
receiving location information indicating a first location of the user from a GPS device comprised by the user device at a first time;
determining a first location verification defined as whether the first location is within a range of an origination location associated with the flight information at the first time;
receiving location information indicating a second location of the user from the GPS device comprised by the user device at a second time;
determining a second location verification defined as whether the second location is within a range of a destination location associated with the flight information at the second time; and
billing the user for transportation on the flight associated with the flight information responsive to the first location verification indicating the user was within the range of the origination location at the first time and the second location verification indicating the user was within the range of the destination location at the second time.
